(19) United States
(12) Patent Application Publication
(10) Pub. No.: US 2021/0381266 A1
(43) Pub. Date: Dec. 9, 2021

(54) METHOD FOR MANAGING AN AUTOMATIC PARKING LOT

(71) Applicant: Stanley Robotics, Versailles (FR)

(72) Inventors: Aurélien Cord, Paris (FR); Clément Boussard, Paris (FR); Olivier Laromiguiere, Paris (FR); Guillaume Giffo, Paris (FR)

(73) Assignee: Stanley Robotics, Versailles (FR)

(21) Appl. No.: 17/416,355

(22) PCT Filed: Dec. 20, 2019
(86) PCT No.: PCT/FR2019/053229

§ 371 Date: Jun. 18, 2021

(30) Foreign Application Priority Data
Dec. 20, 2018 (FR) 1873640

(51) Int. Cl. E04H 6/42; E04H 6/24; G08G 1/14

(52) U.S. Cl. CPC E04H 6/422; G08G 1/146; G08G 1/148; E04H 6/24

(57) ABSTRACT

A method for managing an automatic parking lot involves determining a target space depending on an expected departure date of the vehicle, using a computation including allocating, to a new vehicle entering the lot, a target storage space according to the following rule: selection of spaces corresponding to one of the following criteria: o in the case where a row comprises at least one available proximal space, in front of a vehicle associated with a departure date after the departure date of the entering vehicle, o in the case where a row comprises at least one distal proximal space, positioning in a row the last vehicle of which is associated with a departure date before the departure date of the entering vehicle, allocating the target space to one of the selected spaces—otherwise allocating a space in a temporary storage zone including lanes of consecutive spaces.

### CROSS-REFERENCE TO RELATED APPLICATIONS

This application is a national phase entry under 35 U.S.C. § 371 of International Patent Application PCT/FR2019/053229, filed Dec. 20, 2019, designating the United States of America and published as International Patent Publication WO 2020/128381 A1 on Jun. 25, 2020, which claims the benefit under Article 8 of the Patent Cooperation Treaty to French Patent Application Serial No. 1873640, filed Dec. 20, 2018.

### TECHNICAL FIELD

The present disclosure relates to the field of automatic parking lot systems with a high storage density making it possible to optimize the use of zones of various shapes.

### BACKGROUND

A traditional conventional parking lot wastes a tremendous amount of space. The parking space is often much larger than what is strictly necessary for the vehicles. This makes it easier for drivers to maneuver and allows the doors to be opened once the car is parked. In addition, a conventional parking lot is deeper and the ceilings are higher to allow drivers and pedestrians to move around.

This is why driverless parking solutions and automatic parking lot systems are being developed.

Automatic parking lot systems limit the loss of space specific to conventional parking lot facilities. An automatic mechanical system takes charge of the vehicle and transports it to its parking space. Then, on return, when the driver comes to collect their car, an automatic car movement system returns it to the driver. Thus, the spaces provided for parking are much smaller and the traffic lanes can be optimized. In addition, no pedestrian moves inside the automatic parking lot. The driver deposits and retrieves their vehicle in an open and generously lit airlock at the entrance to the parking lot: the driver does not therefore have to walk through deserted aisles that are often unwelcoming to find their car.

Patent application US2005/207876 is known in the state of the art, describing an automatic vehicle parking system with at least one parking level, which comprises several transporters, movable in all directions around the level in question, each transporter making it possible to move a vehicle, and at least one central computer for wireless control of transporters for the purpose of moving to a desired location, in a configuration with at least one parking destination and/or parking recovery path. The system comprises a transporter tracking mechanism that tracks the position of the transporters; and optionally, at least one lifting mechanism for the vertical movement of the transporter toward a specific parking level. The system also comprises access bays making it possible to place an arriving vehicle on a transporter and to retrieve an exiting vehicle from the transporter. Preferably, the system comprises storage devices for accepting, releasing and reloading one or more transporters, and preferably also entry stations that measure the vehicle dimensions. Multi-story storage requires physical infrastructure and complex and expensive real estate.

In addition to the drawbacks specific to certain embodiments (complexity and cost of multi-story solutions, space lost for side loading of vehicles, etc.), the known solutions do not make it possible to optimize both storage space and reaction time. In fact, to reduce dead spaces, the solutions of the prior art store vehicles in dense rows, with no free space for lateral clearance and by successive filling of the available rows. Storage and retrieval is then carried out according to a “first in first out” (FIFO) logic. However, one user frequently needs to recover their vehicle before another user who had deposited their vehicle before the first user. In this case, if the two vehicles are in the same row, the FIFO logic requires removing all the vehicles from the row preceding that of the user in question to allow access to their vehicle, then repositioning the removed vehicles to clear access. This causes a significant loss of time, not to mention the need for temporary storage space for the temporarily removed vehicles.

### BRIEF SUMMARY

In order to address these drawbacks, the present disclosure relates in its most general sense to a method for managing an automatic parking lot comprising at least one means for guiding vehicles between a reception zone and a storage zone, characterized in that:
The storage zone comprises N storage lanes containing, in alignment, at least M spaces, M being greater than 2
The method involves determining the target space depending on the expected departure date of the vehicle, using a computation consisting in allocating, to a new entering vehicle, a target storage space according to the following rule:
   Selection of spaces corresponding to one of the following criteria:
      In the case where a row comprises at least one available proximal space, in front of a vehicle associated with a departure date after the departure date of the entering vehicle,
      In the case where a row comprises at least one distal proximal space, that is to say, far from the reception zone, positioning in a row the last vehicle of which is associated with a departure date before the departure date of the entering vehicle,
      Allocating the target storage space to one of the selected spaces,
      Otherwise allocating a space in a temporary storage zone consisting of P lanes of Q consecutive spaces, Q being lower than 3.

Advantageously, the method comprises steps executed between two reception sequences of a new vehicle, consisting in executing a method for processing to reevaluate the distribution optimized depending on the departure dates of the set of vehicles in stock and a command to move at least one operating vehicle toward a space allocated by the processing.

According to one variant, the selection step further comprises processing to minimize the time intervals between two consecutive vehicles.

According to another variant, the selection step further comprises processing to minimize the distance of the allocated vehicle space with respect to the reception zone.

According to another variant, the selection step further comprises processing to allocate the most distant zone if the deposit duration is greater than the reference duration of the vehicles present.

According to a particular embodiment, the reference duration corresponds to the median of the durations of the vehicles present.

The present disclosure also relates to an automatic parking lot comprising at least one vehicle movement robot, at least one reception zone for entering vehicles and a storage zone, wherein the storage zone comprises N storage lanes containing, in alignment, at least M spaces, M being higher than 2, and in that the automatic parking lot further comprises a computer controlling the movement of the robot according to a computer program computing, for an entering vehicle, the location of the target space depending on the expected departure date, according to a computation consisting in allocating a target storage space to a new entering vehicle according to the following rule:
Selecting spaces corresponding to one of the following criteria:
   In the case where a row comprises at least one available proximal space, in front of a vehicle associated with a departure date after the departure date of the entering vehicle
   In the case where a row comprises at least one distal proximal space, positioning in a row the last vehicle of which is associated with a departure date before the departure date of the entering vehicle,
Allocating the target space to one of the selected spaces
Otherwise allocating a space in a temporary storage zone consisting of P lanes of Q consecutive spaces, Q being lower than 3.

Advantageously, the parking lot comprises a plurality of autonomous vehicle movement robots.

### BRIEF DESCRIPTION OF THE DRAWINGS

The present disclosure will be better understood on reading the description of a non-limiting example embodiment that follows, with reference to the accompanying drawings, where:

FIG. 1 shows a schematic view of the reception zone of an equipment item according to the present disclosure;

FIG. 2 shows a schematic view of the infrastructure of a reception zone for an equipment item according to the present disclosure; and

FIG. 3 shows a schematic view of the entire installation according to the present disclosure.

### DETAILED DESCRIPTION

The present disclosure relates to an infrastructure and a technical solution for the automated management of motor vehicle parking in a space optimized to increase the density of the parking lot and to reduce the time it takes to deposit and collect the vehicle.

This is, for example, a temporary vehicle parking infrastructure near an airport or a train station, or even on a temporary storage zone of a vehicle manufacturer or distributor.

The infrastructure that is the subject of the present disclosure comprises a public zone that is accessible to users, and a protected zone that is inaccessible to users, where essentially autonomous robots circulate.

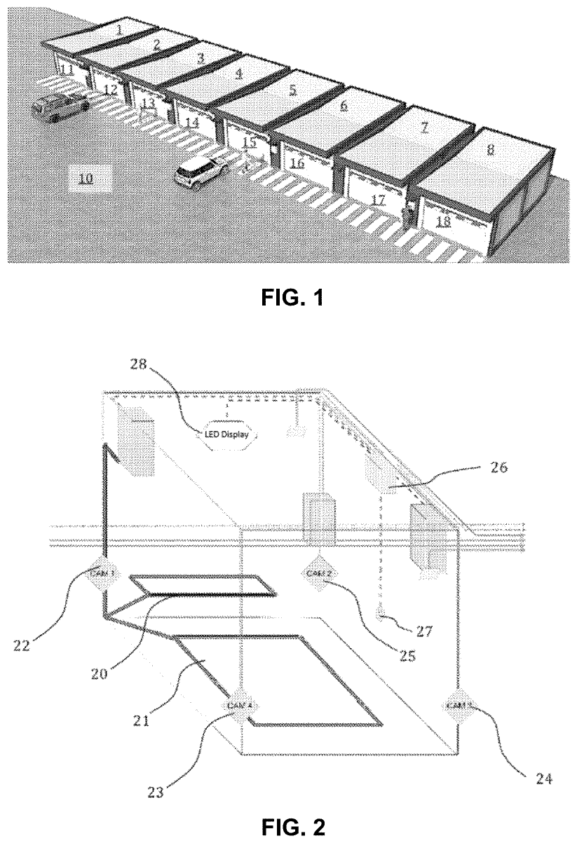

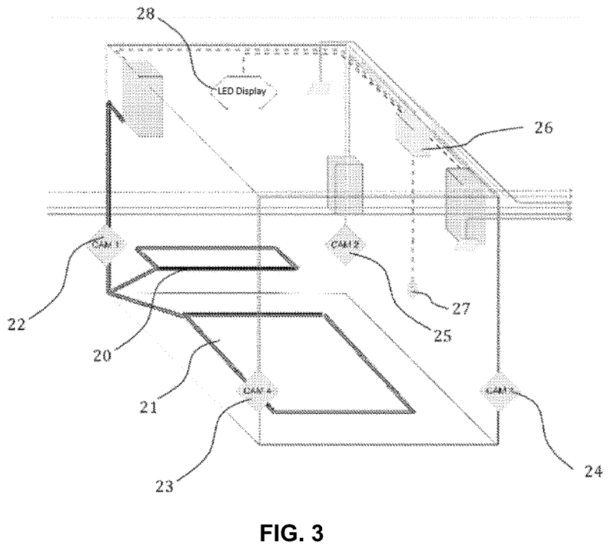

The transfer from the public zone to the protected zone is ensured by a reception zone that will be described in detail according to an embodiment with reference to FIGS. 1 and 2.

Reception Zone

The reception zone is made up of an access road (10) on which are installed, in alignment, shelters (1 to 8) opening on the side of the public zone comprising the access road (10) by automatic doors (11 to 18), and symmetrically, automatic doors opening on the opposite side toward the protected zone.

A first loop (20) formed by a metal cable is arranged in front of the door of each of the shelters to detect the presence of a vehicle. Each shelter (1 to 8) comprises a second loop (21) embedded in the ground to detect the presence of a vehicle in the shelter. The shelter also comprises video surveillance cameras (22 to 25) for the installation. An electrical safety cabinet (26) associated with an extrication button (27) controls the emergency opening of the door in the event of actuation by a user.

A display panel (28) displays service information.

Protected Zone

The protected zone (30) comprises a series of N main storage lanes (31 to 41), each capable of receiving M vehicles, and accessible at each of their ends.

It also comprises transitional storage lanes (51 to 53), each capable of receiving one or more vehicles, accessible from at least one side.

It may further comprise autonomous robots (60), for example, of the type described in patent EP3297876A1, the content of which is incorporated by citation. Such a robot for moving four-wheeled vehicles comprises a frame provided with arms that are movable between a position in which they allow the movement of the frame under the vehicle, and a position in which they come into contact with the treads of the wheels, wherein the frame is telescopic and comprises two segments each carrying a pair of arms. At least one of the pairs of arms is articulated to allow movement between a position perpendicular to the longitudinal axis of the frame with an extension at least equal to the track of the vehicle, and a folded-up position to occupy a width that is less than the distance between the inner sides of the vehicle wheels. The segments are movable between a position where the arms are not in contact with the wheels, and a position where each arm comes into contact with the tread of one of the wheels, to raise or lower the vehicle. The height of the frame and of the elements that it supports, for the part intended to be engaged under the vehicle to be transported, is determined to be less than the ground clearance of the vehicle.

This robot can grasp any vehicle by engaging the telescoping frame under the vehicle by a longitudinal movement. The movement of the articulated arms ensures the locking and the lifting of the wheels to then allow the movement of the vehicle.

A computer center controls the movement of the conveyor robots and, in particular, the designation of the target location in the protected zone, in one of the available locations of one of the storage lanes (31 to 41) or of one of the transitional storage lanes (51 to 53).

The location allocation criteria are determined based on the date and time of arrival of the vehicle in the reception zone and the scheduled departure date. The departure and optionally arrival time are known through the online parking reservation process, or by entering them on user interface equipment installed in each shelter.

The allocation of the location for the first vehicle arriving in the reception zone, when parking is initialized, involves assigning the location closest to the removal zone, in the lane closest to the removal zone (61,62).

For the following vehicle:
If the scheduled departure date is later than the departure date of a vehicle already present in the protected zone, the allocation will be the location in the same row as a car that is already parked.
Otherwise, the allocation will be the first location of a new row.
And otherwise, the allocation will be a temporary transitional storage lane (51 to 53).

In the case where a vehicle at the head of the row of storage lanes (31 to 41) has been removed by the robot (60) and a new vehicle arrives in the reception zone (10) with a departure date before the departure zone of the vehicle stored behind the vehicle that has just been removed, the location in question will be allocated to the new vehicle, which will be moved there by the robot (60).

The computer periodically reassesses the organization of the parked vehicles, in particular, taking into account any modifications to the removal times, in order to recompute an optimized allocation. The vehicles in the protected zone are then moved in the background for repositioning in accordance with the result of this processing.

1. A method for managing an automatic parking lot including at least one means for guiding vehicles between a reception zone and a storage zone, the storage zone comprising N storage lanes containing, in alignment, at least M spaces, M being higher than 2, the method comprising determining a target space depending on an expected departure date of the vehicle, using a computation including allocating, to a new entering vehicle, a target storage space according to the following rule:
selecting spaces corresponding to one of the following criteria:
in the case where a row comprises at least one available proximal space, in front of a vehicle associated with a departure date after the departure date of the entering vehicle;
in the case where a row comprises at least one distal proximal space, positioning in a row the last vehicle of which is associated with a departure date before the departure date of the entering vehicle;
allocating the target space to one of the selected spaces;
otherwise allocating a space in a temporary storage zone comprising P lanes of Q consecutive spaces, Q being lower than 3.

2. The method of claim 1, further comprising steps executed between two reception sequences of a new vehicle, comprising executing a method for processing to reevaluate the distribution optimized depending on the departure dates of the set of vehicles in stock and a command to move at least one operating vehicle toward a space allocated by the processing.

3. The method of claim 1, wherein the selection step further comprises processing to minimize time intervals between two consecutive vehicles.

4. Method for managing an automatic parking lot according to claim 1, wherein the selection step further comprises processing to minimize the distance of the allocated vehicle space with respect to the reception zone.

5. The method of claim 1, wherein the selection step further comprises processing to allocate a most distant zone if a deposit duration is greater than a reference duration of the vehicles present.

6. The method of claim 5, wherein the reference duration corresponds to the median of the durations of the vehicles present.

7. An automatic parking lot comprising at least one vehicle movement robot, at least one reception zone for entering vehicles and a storage zone, the storage zone comprising N storage lanes containing, in alignment, at least M spaces, M being higher than 2, the automatic parking lot further comprising a computer controlling movement of the robot according to a computer program computing, for an entering vehicle, a location of a target space depending on an expected departure date, according to a computation that includes allocating a target storage space to a new entering vehicle according to the following rule:
selecting spaces corresponding to one of the following criteria:
in the case where a row comprises at least one available proximal space, in front of a vehicle associated with a departure date after the departure date of the entering vehicle;
in the case where a row comprises at least one distal proximal space, positioning in a row the last vehicle of which is associated with a departure date before the departure date of the entering vehicle;
allocating the target space to one of the selected spaces.
otherwise allocating a space in a temporary storage zone comprising P lanes of Q consecutive spaces, Q being lower than 3.

8. The automatic parking lot of claim 7, further comprising a plurality of autonomous vehicle movement robots.
